(19) United States
(12) Patent Application Publication
(10) Pub. No.: US 2004/0194222 A1
(43) Pub. Date: Oct. 7, 2004

(54) Polyisobutene as substitute for wool fat in stuffing agents for the production of leather, the stuffing agent, the use thereof and the produced leather

(76) Inventors: Gunther Pabst, Mannheim (DE); Stefan Adams, Ludwigshafen (DE); Andreas Seitz, Birkenheide (DE); Ralph Lunkwitz, Neustadt (DE); Karl Vill, Limburgerhof (DE)

Correspondence Address: KEIL & WEINKAUF, 1350 CONNECTICUT AVENUE, N.W., WASHINGTON, DC, 20036, US

(21) Appl. No.: 10/487,610

(22) PCT Filed: Sep. 6, 2002
(86) PCT No.: PCT/EP02/10018

(30) Foreign Application Priority Data
Sep. 7, 2001 (DE) 101 43 948.2

(51) Int. Cl. C14C 1/00

(52) U.S. Cl. 8/94.15

(57) ABSTRACT

Described is the use of polyisobutene and polyisobutene derivatives as a replacement for raw and refined and optionally chemically modified wool grease and wool grease mixtures in preparations, especially fatliquoring compositions, for leather manufacture.

Also described are preparations, especially fatliquoring compositions, including polyisobutene and/or polyisobutene derivatives and their use in leather production and also a method for making these preparations and the leathers produced using these preparations.

The present invention relates to the use of polyisobutene and polyisobutene derivatives as a replacement for raw and/or refined and optionally chemically modified wool grease and wool grease mixtures in fatliquoring compositions for leather manufacture, to preparations, especially fatliquoring compositions, including polyisobutene and their use in leather production, and also to a process for producing these preparations and to the leathers produced using these preparations.

Fatliquoring agents are used in leather manufacture to render hides and pretanned leathers supple, to increase its fullness and strength and for protection against moisture, dirt and outside chemical influences (see H. Herfeld, “Bibliothek des Leders”, Vol. 4, (1985), p. 13 ff., p. 59 ff., Frankfurt/M.: Umschau Verlag 1987). They shall coat individual hide fibers with a thin film of fat to isolate them from each other and keep them mobile relative to each other, but they shall not completely fill out the interspaces between the fibers since otherwise the porosity and breathability of the leather is impaired.

Commercially available fatliquoring agents generally consist of active components, such as native fats, fatty oils, waxes, resins and derivatives thereof and/or petroleum fractions and downstream products thereof, and waxy products such as “wool grease” in raw, refined and/or compounded (lanolin) form. The active fatliquor components can if desired be chemically modified, ie have a modified chemical structure.

Fatliquors are usually combinations of unmodified active components known as neutral fats and chemically modified active components.

Active fatliquor components are generally chemically modified by subjecting the double bonds in these materials at least in part to addition or oxidation reactions. Examples of frequently practiced modifications are the addition of sulfites, introducing sulfonic acid groups into the fatty substance, and air oxidation, which introduces oxygen functions and may in some instances also give rise to oligomerizations. Other possibilities include the (partial) hydrolysis of the fatty materials, transesterifications and the like modification reactions.

The purpose of these chemical modifications is to optimize properties of the active fatliquor materials that are relevant to performance, for example hydrophilicity, hydrophobicity, solubility, dispersibility, penetration and attachment characteristics, to specific applications or user requirements.

Wool grease, not only in its raw and/or chemically modified form, but especially in its refined and compounded forms (lanolin), is of immense importance in the field of leather manufacture. In the field of leather manufacture, wool grease, especially lanolin, is used as a neutral fat. As well as a fatliquoring and filling effect, it provides a certain hydrophobicizing effect.

Wool grease (lanolin), technically speaking actually a wax, is a fatty secretion from the sebaceous glands of sheep which is recovered from the wool by complex and hence costly methods. Raw wool grease (lanolin) is as the term implies a greasy, malodorous yellowish brown mixture of various esters of palmitic acid, cerotic acid, hexanoic acid, oleic acid, lanoceric acid, myristic acid and lanopalmic acid with cholesterol, lanosterol and agnosterol (which are collectively also known as isocholesterol), 1-hexadecanol and ceryl alcohol. Altogether, more than 30 different fatty acids and aliphatic triterpenoid and steroid alcohols have been identified in wool grease. The malodorous and colored constituents of raw wool grease are mostly destroyed by oxidation in the course of the recovery process. The pure anhydrous wool grease thus obtained, also known as wool wax, is a translucent, pale yellow mass having a faint, pleasant smell and a density from 0.924 to 0.960, a melting point from 36 to 41° C., a saponification number from 95 to 120 and an iodine number from 15 to 30.

Commercially available “lanolin” is a mixture obtained by melting together about 65 parts of wool grease, about 20 parts of water and about 15 parts of viscous paraffin (CD Römpp Chemie Lexikon—Version 1.0, Stuttgart/New York: Georg Thieme Verlag 1995).

Refined and superrefined wool grease known as “neutral wool wax” or “lanolin” is used in cosmetic creams, as a superfatting agent in toilet soaps and in pharmacy where it is used for example in the making of plasters, salves and suppositories and as a release agent in tablet pressing. High end lanolin as used in cosmetics and medicines has a market price of about 8-10 deutschemarks per kilogram.

Less pure, “inferior” lanolin is incorporated in fatliquoring compositions as a neutral fatliquoring component.

The use of lanolin gives rise to a number of disadvantages, however. Since lanolin is of natural origin, its composition, purity, quality and price will always be prone to fluctuations. For the manufacturers of products which contain lanolin this means there is a constant need to optimize and revise the formulations of their products to ensure consistent quality. Last but not least, the increase in demand for high end lanolin has meant a reduction in the amounts of inferior lanolin available, which has led to an extreme price increase for the latter (from about 2 to 6-8 deutschemarks per kilogram).

It is an object of the present invention to develop a synthetic replacement for wool grease and wool grease mixtures in raw and refined and/or chemically modified form, especially for lanolin, that has similar or superior properties to wool grease, especially lanolin, and that can be used in the field of leather manufacture.

We have found that this object is achieved, surprisingly, on replacing raw and refined and/or chemically modified wool grease (wool wax) and blends based on wool grease by polyisobutene and polyisobutene derivatives, the polyisobutene and polyisobutene derivatives used having a low molecular weight or a high molecular weight, depending on the requirements profile.

An example of a blend based on wool grease for the purposes of this invention is commercially available “lanolin”.

This invention accordingly provides a fatliquoring composition for fatliquoring hides and for making leather, comprising

neutral and/or optionally chemically modified native active components and one or more emulsifiers,

wherein said active components comprise polyisobutene and/or polyisobutene derivatives.

The active components of the fatliquoring compositions according to the invention preferably comprise polyisobutene and/or polyisobutene derivatives of the formula I

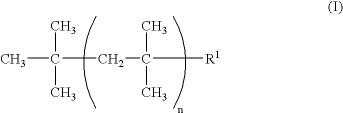

where

n is from 8 to 800, preferably from 12 to 500 and especially from 16 to 100 and

R¹ is a radical of the formula II, III or IV

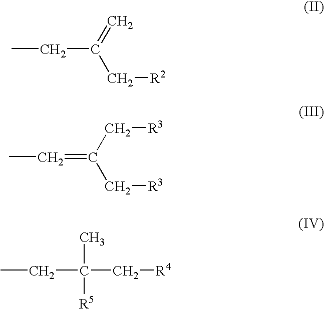

where

R² is hydrogen or an alkyl group of from 2 to 8 (preferably from 2 to 4) carbon atoms which may be substituted by one or two carboxyl or carboxylate groups, alkoxycarbonyl having from 1 to 6 (preferably from 1 to 3) carbon atoms in the alkoxy moiety, alkylamino- or dialkylamino-alkoxycarbonyl having in total from 1 to 6 (preferably from 2 to 4) carbon atoms in the alkylamino or dialkylamino groups, amidocarbonyl, cyano, phenyl, hydroxyl, poly(lower alkoxy), lower acyloxy or by the divalent group —O.CO.O— to form a five- or six-membered ring,

each R³, which may be the same or different, having one of the meanings of R² other than hydrogen,

R⁴ and R⁵, which may be the same or different, are each hydrogen, hydroxyl, lower alkoxy or poly(lower alkoxy),

or one of R⁴ and R⁵ is hydrogen and the other is a sulfato group, (—OSO₃H), a sulfone group (—SO₃H), an amino, alkylamino or dialkylamino group having in total from 1 to 6 (preferably from 2 to 4) carbon atoms in the alkylamino or dialkylamino groups or is a group of the formula —O(CₚH₂ₚ)COOH, where p is an integer from 1 to 7 (preferably from 1 to 3), or a salt thereof or a lower alkyl ester thereof which has from 1 to 5 (preferably from 1 to 3) carbon atoms in the lower alkyl moiety.

Compounds of the formula I can be used in the invention individually or mixed with each other. This permits excellent adaptation of the replacement materials to specific duties.

Polyisobutene conforms to the formula I where R¹ is a radical of the formula II where R² is hydrogen.

Compounds of the formula I where R¹ is a radical of the formula II, III or IV and R² is not hydrogen are polyisobutene derivatives useful for the purposes of the invention.

Poly(lower alkoxy) groups conform to the formula —O(CₘH₂ₘO)ₓH, where m is an integer from 2 to 4 and x is from 1 to 200 and preferably from 3 to 80 and m need not be the same in the individual constituent groups of the polyether chain.

Lower acyloxy groups have in total from 2 to 5 and preferably 2 or 3 carbon atoms. Examples of lower acyloxy are acetyloxy, propionyloxy and butyryloxy.

Preference for the use according to the invention is given to polyisobutene itself (formula I, R¹=group of formula II where R² is hydrogen) and to those compounds of the formula I where R¹ is a radical of formula II or III and especially of the formula II where R² has one of the abovementioned meanings other than hydrogen.

Preference is further given to those compounds of the formula I where alkyl moieties R² and/or R³ contain carboxyl or carboxylic groups or functional derivatives thereof, for example nitriles, amides and especially esters or anhydrides, particular preference being given to 1-alkyl and 2-alkyl moieties in which the stated substituents are attached in position 1 or position 2.

Examples of substituted alkyl groups R² and R³ are: —CH₂CH₂COOH, —CH(CH₃)COOH, —CH₂CH(CH₃)COOH, —CH₂CH₂CH₂COOH, —CH(CH₃)CH₂COOH, —CH(C₂H₅)COOH —CH(C₂H₅)COOH, —CH(CH₃)CH(CH₃)COOH, —C(CH₃)(COOH)C₂H₅, —CH(C₂H₅)CH₂COOH, —CH(C₃H₇)CH₂COOH and/or their salts, amides or nitriles, —CH(COOH)CH₂COOH, —CH(COOH)CH(CH₃)COOH and/or their salts and/or their inner anhydrides —CH(phenyl)CH₂COOH, —CH₂CH₂OCOCH₃, —CH₂CH₂OH and its ethoxylation or propoxylation or butoxylation products.

Polyisobutene itself is produced industrially on a large scale in various grades which differ in molecular weight and sold under various names, for example as ®Oppanols and ®Glissopals. It is generally produced by polymerization of isobutene in the presence of Friedel-Crafts catalysts such as boron trifluoride or aluminum chloride.

Polyisobutene derivatives of the formula I which have carboxyl groups or functional derivatives thereof in R² and/or R³ are advantageously produced from polyisobutene by ene reaction, ie by reacting polyisobutene of the desired molecular weight or compounds of the formula I in which R¹ is a radical of the formula II with enophiles containing the desired substituents. Useful enophiles for this reaction include for example:

acrylic acid, methacrylic acid, vinylacetic acid, crotonic acid, angelic or tiglic acid, cinnamic acid, maleic acid, citraconic acid or esters thereof with alkanols having from 1 to 6 and preferably from 1 to 3 carbon atoms or with alkylamino- or dialkylamino-alkanols having from 2 to 4 carbon atoms in the alkylamino or dialkylamino groups, their amides or their nitriles, maleic anhydride and citraconic anhydride.

To prepare polyisobutene derivatives without carboxyl groups or functional derivatives thereof in R² or R³, appropriately substituted enophiles are reacted with polyisobutene or compounds of the formula I in which R¹ is a radical of the formula II. When for example R² and/or R³ is phenethyl, styrene is useful as enophile, while when R² and/or R³ is acyloxyalkyl, eg acetoxyethyl, vinyl acetate is a useful enophile. Saponification of the acyloxy group and if appropriate subsequent alkoxylation with alkylene oxides leads to R² and R³ moieties containing a hydroxyl or poly(lower alkoxy) group.

The conditions of the ene reaction are known. When comparatively unreactive enophiles are used, the reaction may if desired be appreciably speeded in a known manner by addition of Friedel-Crafts catalysts, for example boron trifluoride or aluminum chloride.

Compounds of the formula I where R¹ is a radical of the formula IV are obtainable from polyisobutene in various conventional ways indicated by way of example in the table which follows:

TABLE
Preparation of compounds of formula I.

| Compound | | | |
|---|---|---|---|
| No. | R4 | R5 | Method |
| 1 | H | H | Hydrogenation |
| 2 | H | OH | Direct or indirect addition of water |
| 3 | OH | H | |
| 4 | OH | OH | Epoxidation and ring opening |
| 5 | H | Lower alkoxy | Addition of alkanol |
| 6 | Lower alkoxy | H | |
| 7/8 | Poly(lower alkoxy)/H | H/poly(lower | Alkoxylation of No. 2 or 3 |
| | | alkoxy) | |
| 9/10 | H/amino groups | Amino groups/H | Addition of amine |
| 11/12 | OH/amino groups | Amino groups/OH | Epoxidation and reaction with |
| | | | amine; hypohalite addition to form |
| | | | halohydrin and reaction with amine |
| 13/14 | —O(CₚH₂ₚ)COOH/ | OH/ | Epoxidation and reaction with |
| | OH | —O(CₚH₂ₚ)COOH | α-halocarboxylic acid (derivatives) |
| 15/16 | H/—OSO₃H | —OSO₃H/H | Addition of sulfuric acid |
| 17/18 | H/—SO₃H | —SO₃H/H | Addition of sulfite |

Neutral fatliquor components are fatty materials containing long or comparatively long alkyl moieties devoid of any anionic or cationic groups, for example white oil, paraffins, native oils, silicones or wool wax.

“Lanolin” is frequently used as a neutral fatliquor component.

The raw or refined and/or chemically modified wool grease (wool wax) or lanolin included in leather fatliquoring compositions can be replaced in whole or in part by polyisobutene and/or the polyisobutene derivatives which are to be used according to the invention as a replacement material. It is therefore possible that even fatliquoring compositions according to the invention that include polyisobutene or polyisobutene derivatives, as well as these replacement materials, will still include the optionally chemically modified wool grease or lanolin in question.

Optionally chemically modified native fatliquor components contain an aliphatic moiety of medium or high chain length and one or more hydrophilic groups, preferably anionic in character. Components of this kind which require no chemical modification include for example carboxylic acids of medium and long chain length, for example oleic acid.

Useful chemically modified native fatliquor components include for example wholly or partly sulfated long-chain aliphatic compounds containing one or more olefinic double bonds. The native fatliquor components used are advantageously fatty materials of vegetable or animal origin, especially glycerides of natural fatty acids containing a sufficient proportion of unsaturated acids.

Very useful fatty materials include vegetable and animal fats and oils having an iodine number from about 10 to about 200. The lower end of this range accommodates for example stearin and tung oil and the upper end especially the fish oils and chaulmoogra oil.

Which fatty materials are selected depends among other factors also on the specific end use to which the mixture according to the invention is to be put. For instance, the use of fish oils may be undesirable for the production of fancy leather goods because of the odor adhering to these fats.

Preference is given to fatty materials having iodine numbers from about 30 to about 120 and especially from 40 to 85.

Examples of particularly preferred fatty materials are tallows of different origins, bone oil, neat's foot oil, especially neat's foot oil from cattle only, lard oil, triolein, rapeseed oil, olive oil, nut oil and castor oil.

The sulfation products of the mono- and polyunsaturated fatty materials are formed as a result of the reaction of the olefinic double bonds present in the fatty materials with the sulfating reagents. All or only some of the double bonds present in the fatty materials may enter the reaction.

Of particular use for the purposes of the invention is for example oxidized triolein.

The group of the chemically modified native fatliquor components also includes chemically modified wool grease (wool wax).

Useful emulsifiers for the fatliquoring compositions according to the invention include all emulsifiers customary in tanning agents, known fatliquoring compositions and other assistants used in leather manufacture. Advantageously, the emulsifiers used in the fatliquoring compositions of the invention are nonionic or anionic materials, preferably fatty alcohols (ie alcohol mixtures having from 10 to 25 carbon atoms) or alkoxylated fatty alcohols having from 5 to 100 alkylene oxide groups or their sulfates or phosphates.

It is particularly advantageous to use emulsifier combinations, for example combinations composed of alkoxylated fatty alcohols having fewer than 15 and preferably fewer than 10 alkylene oxide units and/or alkoxylated fatty alcohols having more than 20 and preferably from 20 to 40 alkylene oxide units and/or fatty alcohols having more than 60 alkylene oxide units.

The fatliquoring compositions according to the invention advantageously include neutral and/or optionally chemically modified native active components in a fraction from 0 to 97%, preferably from 8 to 85% and especially from 26-67% by weight,

one or more compounds of the formula I in a fraction of in total from 2 to 90%, preferably from 13 to 80% and especially from 30 to 65% by weight,

and one or more emulsifiers in a fraction from 1 to 20%, preferably from 2 to 12% and especially from 3 to 9% by weight.

Generally, from 20 to 100% by weight, preferably from 40 to 100% by weight and especially from 80 to 100% by weight of the neutral fatliquor components and/or from 0 to 90% by weight, preferably from 0 to 80% by weight and especially from 0 to 70% by weight of the optionally chemically modified native fatliquor components were composed of polymers of the formula I.

According to the invention, the compounds of the formula I are particularly advantageously included in those fatliquoring compositions which traditionally include wool grease in raw or refined and/or chemically modified form or in the form of compounds (lanolin). In these fatliquoring compositions, they may replace all or some of the wool grease. This results not only in cost advantages, but also in a consistently high quality for the fatliquoring compositions owing to the independence from fluctuations in wool grease quality.

The present invention further provides a process for preparing polyisobutenic fatliquoring compositions by mixing

(a) at least one neutral and/or optionally chemically modified native active component and

(b) a polyisobutene and/or polyisobutene derivative component in the presence of

(c) one or more emulsifiers

and homogenizing and stabilizing the dispersion thus obtained.

The proportions in which the components a), b) and c) are to be mixed follow from the above composition data for the fatliquoring compositions according to the invention.

It is advantageous to mix the ingredients of the fatliquoring compositions according to the invention in a liquid medium, preferably in water.

Known assemblies can be used for the homogenizing.

The present invention further provides for the use of polyisobutene and/or polyisobutene derivatives, preferably those of the formula I, as a replacement for raw and refined and/or chemically modified wool grease (wool wax) and for blends (e.g. “lanolin”) based on wool grease, in preparations for treating hides and for leather manufacture.

The invention also provides for the use of the fatliquoring compositions according to the invention in leather manufacture to soften the leather, to increase its fullness and strength and to protect it against moisture, dirt and outside chemical influences.

The present invention further provides for the use of the fatliquoring compositions according to the invention for fatliquoring hides and also a process for fatliquoring hides using directly polyisobutene and/or polyisobutene derivatives, in particular those of formula I, in sole application or in combination with other fatliquor, conveniently in the form of aqueous emulsions.

The fatliquoring compositions of the invention preparable by the process according to the invention can be combined in use with known commercially available fatliquoring compositions of native, synthetic and/or polymeric origin. Such combinations can be used to create specific effects on the leather product.

Retanning conditions for the products according to the invention are the same as generally customary. Processing can be based not only on wet blue but also on wet white. Retanning is effected using—based on the shaved weight—from 50 to 100% by weight of water and from 0.5 to 20% by weight of fatliquoring composition at from 20 to 60° C. and at from pH 3.0 to pH 7.5.

The tanning of hides using fatliquoring compositions according to the invention leads to similar or improved results compared with the use of fatliquoring compositions containing wool grease or lanolin.

However, the use of polyisobutene or polyisobutene derivatives instead of lanolin ensures that the leathers produced therewith have a superior, more consistent quality. In addition, the use according to the invention provides a second, independent way of obtaining fatliquored leathers which makes the leather manufacturer independent of price fluctuations and possible bottlenecks in the wool grease market.

Having regard to the novel useful combination of desirable properties of the leathers produced using a fatliquoring composition according to the invention, these leathers likewise form part of the subject matter of the present invention.

The examples hereinbelow illustrate the invention.

### Example 1

### Preparing a Compound of the Formula I

A 4-liter three-neck round-bottomed flask equipped with stirrer, thermometer and air-cooled reflux condenser is charged with 800 ml of o-dichlorobenzene, 1 000 g of a polyisobutene having a relative molecular mass of about 1 000 and 100 g of maleic anhydride with stirring. The mixture is refluxed for 24 hours with stirring.

The reaction mixture is then cooled, the reflux condenser is replaced by a descending condenser and the o-dichlorobenzene is distilled out of the mixture in a water jet vacuum.

This provides about 1 100 g of a raw compound of the formula I where R¹ conforms to the formula II and R² is a succinic anhydride group of the formula

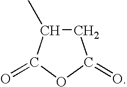

The product can be used in the invention without further purification.

If desired, the anhydride ring of the product can be opened by heating with alkali (sodium carbonate solution or dilute aqueous sodium hydroxide solution) to form a group of the formula

—CH(COO⁻)CH₂COO⁻.

### EXAMPLE 2

### Preparing a Compound of the Formula I

Example 1 is repeated except that 200 g of maleic anhydride are used instead of 100 g and the reaction time is extended to 30 h.

This provides about 1 200 g of a raw compound of the formula I where R¹ conforms to the formula III and each R³ is a succinic anhydride group of the formula indicated in example 1.

The product can be used in the invention without further purification or can be subjected to alkaline hydrolysis as described in example 1.

### EXAMPLE 3

### Preparing a Compound of the Formula I

A 4-liter three-neck round-bottomed flask equipped with stirrer, thermometer and water-cooled reflux condenser is charged with 800 ml of dry o-dichlorobenzene, 1 000 g of a polyisobutene having a relative molecular mass of about 1 000 and 100 g of ethyl acrylate with stirring. The mixture is refluxed for 24 h with stirring.

The reaction mixture is then cooled down, the reflux condenser is replaced by a descending condenser and the o-dichlorobenzene and the unconverted acrylic ester are distilled out of the mixture in a water jet vacuum.

This provides about 1 050 g of a mixture of about 40% by weight of polyisobutene and about 60% by weight of a compound of the formula I where R¹ conforms to the formula II and each R² is a group of the formula

—CH₂CH₂COOC₂H₅ and —CH(CH₃)COOC₂H₅.

The mixed product can be used in the invention without further purification.

### EXAMPLE 4

### Preparing a Fatliquoring Composition

In a reactor, 23 kg of a polyisobutene having a relative molecular mass of about 1 000 are mixed with 3 kg of a fatty alcohol ethoxylated with 25 mol of ethylene oxide, 0.5 kg of a fatty alcohol ethoxylated with 80 mol of ethylene oxide, 4 kg of oleic acid and 23 kg of a sulfited, oxidized triolein and heated also 60° C. 47 kg of water and 1 kg of a fatty alcohol ethoxylated with 7 mol of ethylene oxide are then added. This aqueous emulsion is passed through a homogenizer to obtain a fine, stable emulsion.

### EXAMPLE 5

### Preparing a Fatliquoring Composition

In a reactor, a mixture of 16 kg of a polyisobutene having a relative molecular mass of about 1 000 and 7 kg of a polyisobutene having a relative molecular mass of about 60 000 is mixed with 3 kg of a fatty alcohol ethoxylated with 25 mol of ethylene oxide, 0.5 kg of a fatty alcohol ethoxylated with 80 mol of ethylene oxide, 4 kg of oleic acid and 23 kg of a sulfited, oxidized triolein and heated also 60° C. 47 kg of water and 1 kg of a fatty alcohol ethoxylated with 7 mol of ethylene oxide are then added. This aqueous emulsion is passed through a homogenizer to obtain a fine, stable emulsion.

The compounds obtained in examples 1 to 3 can be used for making preparations in a similar manner to that described in examples 4 and 5.

### EXAMPLE 6 (COMPARATIVE)

Example 4 was repeated with lanolin instead of polyisobutene.

### EXAMPLE 7

### Use Example

100 parts by weight of chrome-tanned cattlehide leather from 2.0 to 2.2 mm in shaved thickness are introduced into 100 parts by weigt of water at 40° C. and adjusted to pH 4.5 by addition of sodium formate and sodium bicarbonate. The leather is drummed at 40° C. for 60 minutes and then washed with 200 parts by weight of water.

This is followed by the addition of 100 parts by weight of water at 40° C. and of 2 parts by weight of commercially available polymeric tanning material, 4 parts by weight of commercially available resin tanning material and 4 parts by weight of commercially available mimosa. After drumming for 90 minutes, the leather is dyed in the same float with 1 part by weight of a commercially available leather dye. The float is then changed and 100 parts by weight of water are added. The leather is then fatliquored with a mixture of 4 parts by weight of commercially available fatliquor and 2 parts by weight of the fatliquor of example 4. The float is then adjusted to pH 3.5-3.8 with formic acid and the leather is briefly rinsed cold and further processed as generally customary. The leather obtained possesses very good color, a firm grain coupled with good fullness and average softness. The leather surface has a fatty hand.

### EXAMPLE 8

### Use Example

Example 7 is repeated using the product of example 5 instead of the product of example 4. The leather obtained has the same performance properties as in example 7, but its surface has an even more fatty hand than in example 7.

### EXAMPLE 9

### Use Example

Example 7 is repeated using the product of example 6 instead of the product of example 4. The leather obtained has the same performance properties as in example 7.

We claim:

1. A fatliquoring composition for fatliquoring hides and for making leather, comprising
neutral and/or optionally chemically modified native active components and one or more emulsifiers,
wherein said active components comprise polyisobutene and/or polyisobutene derivatives of the formula I 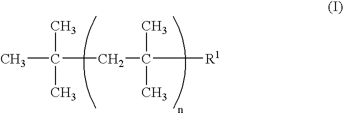
where
n is from 8 to 800 and
R¹ is a radical of the formula II, III or IV 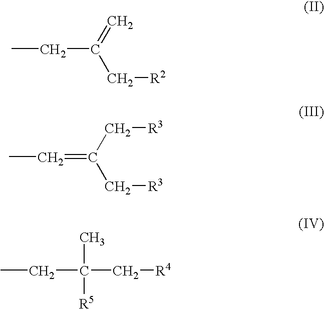
where
R² is an alkyl group of from 2 to 8 carbon atoms which may be substituted once or twice by alkoxycarbonyl having from 1 to 6 carbon atoms in the alkoxy moiety, alkylamino- or dialkylamino-alkoxycarbonyl having in total from 1 to 6 carbon atoms in the alkylamino or dialkylamino groups, amidocarbonyl, cyano, phenyl, hydroxyl, poly(lower alkoxy), or lower acyloxy,
each R³, which may be the same or different, is an alkyl group of from 2 to 8 carbon atoms which may be substituted once or twice by one or two carboxyl or carboxylate groups, alkoxycarbonyl having from 1 to 6 carbon atoms in the alkoxy moiety, alkylamino- or dialkylamino-alkoxycarbonyl having in total from 1 to 6 carbon atoms in the alkylamino or dialkylamino groups, amidocarbonyl, cyano, phenyl, hydroxyl, poly(lower alcoxy), or lower acyloxy, or by the divalent group —O.CO.O⁻ to form a five- or six-membered ring,
R⁴ and R⁵, which may be the same or different, are each hydroxyl, lower alkoxy or poly(lower alkoxy), or
one of R⁴ and R⁵ is hydrogen and the other is hydroxyl, lower alkoxy or poly(lower alkoxy),a sulfato group, (—OSO₃H), an amino, alkylamino or dialkylamino group having in total from 1 to 6 carbon atoms in the alkylamino or dialkylamino groups or is a group of the formula —O(CₚH₂ₚ)COOH, where p is an integer from 1 to 7, or a salt thereof or a lower alkyl ester thereof which has from 1 to 5 carbon atoms in the lower alkyl moiety.

2. A fatliquoring composition as claimed in claim 1, comprising polymers of formula I wherein R¹ is a radical of the formula II and R² is hydrogen.

3. A fatliquoring composition as claimed in either of claims 1 and 2 including mutual and/or optionally chemically modified native active components in a fraction from 0 to 97% by weight,
one or more compounds of the formula I in a fraction of in total from 2 to 90% by weight and
one or more emulsifiers in a fraction from 1 to 20% by weight.

4. The process for preparing polyisobutenic fatliquoring compositions by mixing at least one neutral and/or optionally chemically modified native active component and a component comprising polyisobutene and/or polyisobutene derivative of formula I in the presence of one or more emulsifiers
and homogenizing and stabilizing the dispersion thus obtained.

5. The process of claim 4 wherein said components are mixed in the proportions indicated in claim 3.

6. The use of the fatliquoring composition of claims 1 and 2 in leather manufacture.

7. The use of the fatliquoring composition of claims 1 and 2 for fatliquoring hides.

8. A process for fatliquoring hides, which comprises using directly polyisobutene and/or polyisobutene derivatives in sole application or in combination with other fatliquors, conveniently in the form of aqueous emulsions.

9. The use of polyisobutene and/or polyisobutene derivatives as a replacement for raw and refined and/or chemically modified wool grease (wool wax) and for blends based on wool grease, in preparations for treating hides and for leather manufacture.

10. Leather produced using the fatliquoring composition of claim 1 and 2.
